(19) United States
(12) Patent Application Publication
(10) Pub. No.: US 2007/0134991 A1
(43) Pub. Date: Jun. 14, 2007

(54) UNIVERSAL STEREO PLUG FOR MOBILE TELEPHONES

(76) Inventors: Paramjit Kohli, Cranbourne Victoria (AU); Seok Ki Kim, Ilsan-Gu Koyang-Si Kyonggi-Do (KR)

Correspondence Address: BLUMENFELD, KAPLAN & SANDWEISS, P.C., 168 NORTH MERAMEC, 4TH FLOOR, CLAYTON, MO, 63105-3763, US

(21) Appl. No.: 11/164,900

(22) Filed: Dec. 9, 2005

(51) Int. Cl. H01R 24/04

(52) U.S. Cl. 439/669

(57) ABSTRACT

A universal plug is shown for use with the 4-conductor jacks of some mobile telephones, such as those that play stereo music. The universal plug is especially adapted to work with at least three different standards of various manufacturers, as well as the industry standard 3-conductor jacks of other mobile telephones.

### BACKGROUND OF THE INVENTION

1. Field of the Invention

The present invention relates to a plug, such as those used with headphones, and more particularly to a plug that fits multiple brands of stereo-audio-capable mobile telephones.

2. Description of the Prior Art

Over recent years, the technology in mobile telephones has evolved to incorporate the functionality previously available in other small appliances. This phenomenon, known in the industry as “convergence,” has led to mobile telephones that can be used as alphanumeric pagers, internet browsers, e-mail devices, PDAs, as well as several other technologies. Most recently, it has become popular to combine the functionality of portable music (and even multimedia) players into mobile telephones.

The resulting “music phones” necessitated the development of a headset that could be used both to listen to the music and to use the telephone in a hands-free manner. This hybrid headset not only needed stereo audio output, but a microphone and a control switch, as well. This meant that headset jacks for these devices and the resulting plug design needed to be developed with four conductors. Previous conventional stereo headsets (i.e., those for use with portable music players) have used a 3-conductor plug/jack system with a 3.5 mm diameter (the outside diameter of the plug and approximate inside diameter of the corresponding jack). Previous mobile telephone monophonic headsets with microphone and control button have used a 3-conductor plug/jack system with a 2.5 mm diameter. A de facto standard has been developed for both of these systems, which standardizes the location of the contact points along the plug/jack.

Unfortunately, no standard (de facto, or otherwise) was developed for the new 4-conductor plug/jack systems for use with music phones, despite the fact that all manufacturers appear to use the form factor found in the conventional 2.5 mm system. The exact reason for this lack of standardization is unknown. However it may have been the result of a rush on the part of the major telephone manufacturers to get their music phones to market. Regardless of the genesis of the current situation, it has created problems.

The biggest problem is that manufacturers of after-market mobile telephone accessories have, thus far, needed to develop a separate plug for the music phone headsets for each major manufacturer's music phone. This is costly for several reasons, but the most significant reasons is that it requires accessory manufacturers to create tooling for, and them and their distribution chain to maintain inventory control on, 4 or 5 times as many related products than would have been the case had the industry standardized.

Thus, it is an object of the present invention to develop a 4-conductor plug for use with music phones that can be used with music phones from multiple manufacturers.

It is a further object of the present invention to maximize the number of manufacturer's music phones with which such a plug is compatible.

### SUMMARY OF THE INVENTION

It is with the above objects in mind that the present invention was conceived. The present invention was developed based on the fact that each of the various major manufacturer's 4-conductor plug/jack systems uses the same form factor for the plug—namely a 2.5 mm diameter plug, with a standard length (11.5±0.3 mm). This is the same form factor as used with the 3-conductor systems. The difference between each of the 4-conductor systems is the precise location of the contact points within the jack, and thus the dimensions and locations of the conductor terminations (and the insulators disposed between each adjacent set of conductor terminations) along the plug.

Careful reverse engineering of each different system was required, before it was discovered that precise dimensioning of the conductors and corresponding insulators was possible so that a plug could be used with jacks from multiple systems. This was not a case of merely finding optimal dimensions for the components of the plug. First, it had to be determined that such a multiple-compatible system was even feasible. Additionally, if conductor terminations were made too wide (insulators too narrow), the conductor termination would make contact with multiple jack contact points in some systems. Conversely, if conductor terminations were made too narrow (insulators too wide), the conductor termination would miss contact with the corresponding contact point in the jack of some systems. Both of these scenarios are obviously unacceptable, as this would cause the otherwise stereophonic audio to be heard in only one ear piece, or in some cases, no audio output at all.

Eventually, a plug was discovered with precise dimensioning that is compatible with the 4-conductor systems of three different major music phone manufacturers. Specifically, a headset made with this plug will provide stereophonic audio as well as telephone control, with music phones made by Motorola®, LG®, and Samsung®. This universal plug still uses a 2.5 mm diameter by 11.5 mm form factor, and is even compatible with jacks on conventional mobile telephones using the standard 3-conductor system.

### BRIEF DESCRIPTION OF THE DRAWINGS

So that the manner in which the above-identified features, advantages, and objects of the present invention are attained and can be understood in detail, a more particular description of the invention, briefly summarized above, may be had by reference to the embodiment thereof which is illustrated in the appended drawings.

It is noted however, that the appended drawings illustrate only a typical embodiment of this invention and is therefore not to be considered limiting of its scope, for the invention may admit to other equally effective embodiments. Reference the appended drawings, wherein:

FIG. 1 is a general representation of the standard form factor for a 4-conductor plug;

FIG. 2 is a cutaway view of a prior art 3-conductor plug in a conventional 3-conductor jack;

FIG. 3 is a cutaway view of the plug of the present invention in a conventional 3-conductor jack; and

FIG. 4 is a cutaway view of the plug of the present invention in a 4-conductor jack, generally.

### DETAILED DESCRIPTION OF THE PREFERRED EMBODIMENT

Referring now to FIG. 1, the form factor of a 4-conductor plug 10 is shown generally. This genre of plug is typically used with headsets designed to listen to stereo audio from a mobile telephone, while at the same time providing an audio input (microphone) to the telephone and a control means, such as a single-pole, single-throw, momentary switch (which can function to answer or make telephone calls depending on the model of telephone).

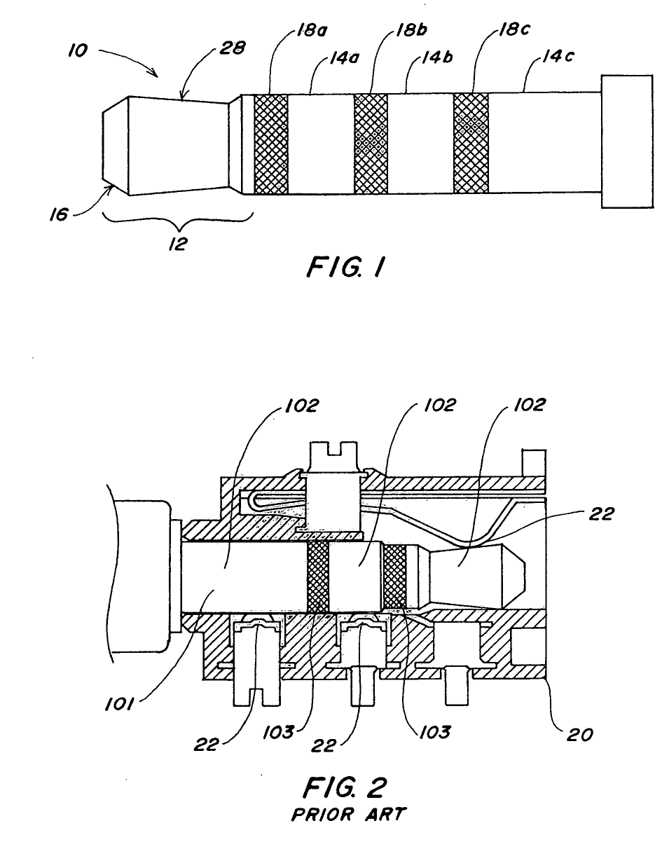

The plug 10 is generally cylindrical and comprises a tip 12 which acts as a conductor termination for one of the conductors of the headset and three more conductor terminations 14a, 14b, and 14c that are collinear with the tip are disposed along the surface of the plug 10. The tip 12 is not cylindrical like the remainder of the plug, but rather has a beveled end 16 and a beveled indentation 28 to allow the entire plug 10 to be retained by the corresponding jack (as best seen in FIGS. 2-4). In between each adjacent conductor termination 12, 14, is disposed an insulator ring 18a, 18b, and 18c so that no two conductors are in electrical contact with one another, which would obviously create a short in the headset circuit.

The drawing of FIG. 1 is not drawn to scale because of the very nature of the problem to be solved. Each manufacturer of mobile telephones uses different dimensions of the various electrical contact points within the jack, and thus the dimensions and placement of the conductor terminations are different for each manufacturer. Only the form factor is common among the various manufactures. The diameter of the plug is 2.5 mm and the length from the end of the tip 16 to the distal end of the last conductor termination 14c is 11.5 mm (±0.3 mm). The following table shows the different lengths of the components of the plug 10 in millimeters (rounded to the nearest 0.05 mm) in the system of various manufacturers:

TABLE 1
Length of 4-Conductor Plug Components in Various Systems

| | | 1^{st} | 1st | 2nd | 2nd | 3rd | 3rd |
|---|---|---|---|---|---|---|---|
| | | Insulator | Conductor | Insulator | Conductor | Insulator | Conductor |
| | | Ring | Termination | Ring | Termination | Ring | Termination |
| | Tip Length | Length | Length | Length | Length | Length | Length |
| Manufacturer | (12) | (18a) | (14a) | (18b) | (14b) | (18c) | (14c) |
| LG | 3.80 | 0.85 | 1.20 | 0.75 | 1.30 | 0.75 | 3.00 |
| Samsung | 4.00 | 0.75 | 1.25 | 0.80 | 1.20 | 0.80 | 2.90 |
| Motorola | 3.90 | 0.75 | 1.55 | 0.65 | 1.55 | 0.75 | 2.30 |

The present invention is a specially modified version of the plug 10 that works with jacks of the 4-conductor plugs of at least the three manufacturers mentioned above. This is accomplished by very carefully designing the dimensions and location of the conductor terminations 14. In the present invention, the tip is 3.7 mm long, and the remaining conductor terminations 14a, 14b, and 14c, are 1.4 mm, 1.4 mm, and 2.9 mm respectively. The widths of the insulator rings, 18a, 18b, and 18c, are 0.7 mm, 0.5 mm, and 0.6 mm respectively.

FIG. 2 shows how a similar, prior art, 3-conductor plug 101 fits in a 3-conductor jack 20. Note that the plug 101 has three conductor terminations 102 (including the tip), each of which is separated from the adjacent conductor terminations 102 by an insulator ring 103, and each of which makes contact with exactly one electrical contact point 22 in the jack 20.

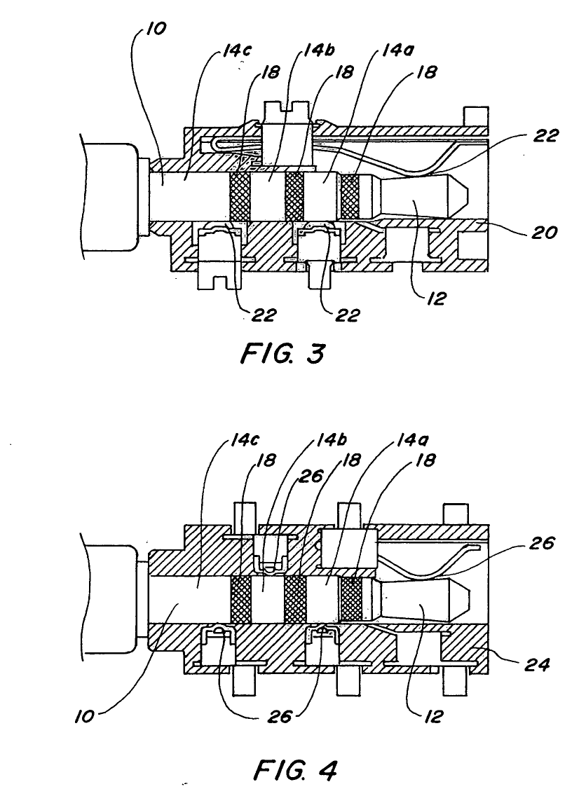

In the present invention, the plug 10 is also compatible with the standard 3-conductor jack 20, which can be seen in FIG. 3. Note that the first, second, and fourth conductor terminations 12, 14a, and 14c make contact with the electrical contact points 22.

FIG. 4 shows the similar situation of the plug 10 of the present invention fitting inside a 4-conductor jack 24 of an unspecified manufacturer. This drawing represents a compatible fit between the plug 10 and this jack 24. Note that each conductor termination 12, 14 makes contact with exactly one electrical contact point 26 in the jack, and consequently no electrical contact point 26 is located on an insulator ring 16 when the plug 10 is inserted.

Other manufacturers may choose to adopt yet different standards for their 4-conductor plug/jack systems, and the present invention may or may not need to be modified accordingly. Such adaptations are contemplated as being within the scope of the present invention. It may or may not even be possible to find a solution to dimensions and placement of the conductor terminations 12, 14 such that compatibility can be maintained with the three known systems discussed herein and the aforesaid new standard yet to be created.

While the foregoing is directed to the preferred embodiments of the present invention, other and future embodiments of the invention may be devised without departing from the basic scope thereof, and the scope thereof is determined by the claims which follow.

What is claimed is:

1. In a plug having a form factor consisting of a generally cylindrical body, a tip, four conductor terminations co-linearly disposed about the outside of the body, three insulator rings disposed between the conductors, the improvement comprising adapting the spacing and dimensions of the conductor terminations and corresponding insulator rings, such that each conductor termination makes contact with exactly one electrical contact point in at least two different jack standards, each having four electrical contact points, designed to accept plugs of that form factor.

2. The improvement of claim 1, wherein said plug works as described with three different jack standards, each having four electrical contact points, designed to accept plugs of that form factor.

3. The improvement of claim 2, wherein the first, second, and fourth conductor terminations, as counted from the tip, each make contact with exactly one electrical contact point in a jack standard having three electrical contact points, and designed to accept plugs of that form factor.

4. The improvement of claim 3, wherein the insulators are 0.7 mm, 0.5 mm, and 0.6 mm in length respectively, as counted from the tip.

5. The improvement of claim 4, wherein the tip comprises the first conductor termination, and is 3.7 mm in length, and the remaining conductor terminations counted from said tip are 1.4 mm, 1.4 mm, and 2.9 mm in length respectively.
